(19) United States
(12) Patent Application Publication
(10) Pub. No.: US 2011/0214059 A1
(43) Pub. Date: Sep. 1, 2011

(54) Media Distribution in a Content Delivery Network

(76) Inventors: Ashley Edwardo King, Tijeras, NM (US); Steve J. Shattil, Cheyenne, WY (US)

(21) Appl. No.: 13/036,171

(22) Filed: Feb. 28, 2011

Related U.S. Application Data
(60) Provisional application No. 61/308,997, filed on Mar. 1, 2010.

(51) Int. Cl. G06F 15/177; G06F 3/048

(52) U.S. Cl. 715/735

(57) ABSTRACT

A control board residing in a content delivery network interacts with a canvas display on a client device. The canvas displays a plurality of user-selectable client devices and a plurality of user-selectable media resources. The control board comprises a media routing module that is responsive to the client-device canvas for displaying available media resources for each of the client devices. The control board also comprises a media rendering module that is responsive to a user's selection of at least one client device and at least one media resource for providing device-specific configuring of the selected media resource. The control board may comprise a canvas display module responsive to at least one of the media routing module, the media rendering module, and the canvas for configuring the canvas display.

### BACKGROUND OF THE INVENTION

I. Field of the Invention

The present invention relates to a system and a method for a content delivery network (CDN), and in particular, to such a system and method for managing resources for content distribution.

II. Description of the Related Art

Distributed computer systems are well-known in the prior art. One such distributed computer system is a content delivery network, or CDN, that is operated and managed by a service provider. The service provider typically provides the service on behalf of third parties. A distributed system of this type typically refers to a collection of autonomous computers linked by a network or networks, together with the software, systems, protocols and techniques designed to facilitate various services, such as content delivery or the support of out-sourced site infrastructure.

A content delivery network employs a collection of content servers and associated control mechanisms to offload work from Web site origin servers by delivering content on their behalf to end users. A well-managed CDN achieves this goal by serving some or all of the contents of a site's Web pages, thereby reducing the customer's infrastructure costs while enhancing an end-user's browsing experience. In operation, the CDN uses a request routing mechanism to locate a CDN content server close to the client to serve each request directed to the CDN, where the notion of “close” is based, in part, on evaluating results of network traffic tests.

As the variety and sophistication of media resources on a CDN grows, providers of web content and applications increasingly need to manage content and how content is displayed on client devices. This need generates several challenges, including, among others, how to manage media resources from both the server side and the end-user side, how to adapt the delivery of media resources to different types of client devices, and how to guarantee a seamless user experience when transitions between client devices and between networks occur.

### SUMMARY OF THE INVENTION

Aspects of the present invention solve these and other problems by providing control-board applications across multiple functional domains that allow both user control and content-provider control of media resources. Aspects disclosed herein may be advantageous for CDN systems. However, the invention is not intended to be limited to such systems, as other applications may benefit from similar advantages.

One aspect of the present invention is directed towards methods, systems, and computer-readable media comprising program code for enabling content providers to manage user interactions with media resources. For example, a control board is configured for interacting with a user-device canvas, which displays user-controlled devices and media resources. The control board is responsive to user selection of a client device for configuring and delivering media resources to the selected client device. The control board enables user control for routing media resources to user-selected client devices, and provides for configuring the media resources according to the needs of at least one of the users and the client devices. The control board may comprise hardware, software, or any combination thereof.

In accordance with one aspect of the invention, at least one client device comprises a mobile terminal communicatively coupled to a mobile wireless network. The step of configuring the media resources includes analyzing wireless link performance of the mobile terminal, and/or performance of the wireless network for selecting which media resources to make available to the client device.

According to another aspect of the invention, a control-board application for enabling a content provider to manage user access to media resources comprises a content-aggregation means, a content-management means, and a content-acquisition means. The content-aggregation means is configured for aggregating a plurality of media resources, the content-management means is configured for managing client access to media, and the content-acquisition means is configured for distributing the media resources to a plurality of disparate client devices. In particular, the content-acquisition means may provide a client display and enable both client control and content-provider control of media streams to the plurality of client devices. In one aspect of the invention, at least one of the content-management means and the content-acquisition means is configurable for adapting the flow of media resources based on performance of a wireless network serving the client devices.

### BRIEF DESCRIPTION OF THE DRAWINGS

The invention is illustrated in the figures of the accompanying drawings which are meant to be exemplary and not limiting, in which like references are intended to refer to like or corresponding parts, and wherein:

FIG. 1 is a block diagram of CDN employing a hierarchical computing system according to one aspect of the invention;

FIG. 2 is a block diagram of a control board configured in accordance with an aspect of the invention;

FIG. 3 is a flow diagram of a control-board method for managing user interactions with media resources in accordance with an aspect of the invention;

FIG. 4 is a block diagram depicting code segments of a computer program configured in accordance with one aspect of the invention;

FIG. 5 illustrates a media resource rendering method according to one aspect of the invention;

FIG. 6 is a block diagram of a control-board application for enabling a content provider to manage user access to media resources;

FIG. 7 is a block diagram of a network configuration pertaining to the function of a content-acquisition means according to one aspect of the invention; and

FIG. 8 is a block diagram of a plurality of plasma objects that may be employed by a control board in accordance with aspects of the invention.

### DETAILED DESCRIPTION

The subject matter described herein may be implemented in a CDN, such as illustrated in the Figures. Use in a CDN is a not a limitation, however, as the subject matter may be implemented in any environment in which one entity operates a distributed network from which third party content is distributed.

In the following description, reference is made to the accompanying drawings that form a part hereof, and in which is shown by way of illustration specific aspects in which the invention may be practiced. It is to be understood that other aspects and embodiments may be utilized, and structural changes may be made without departing from the scope of the present invention.

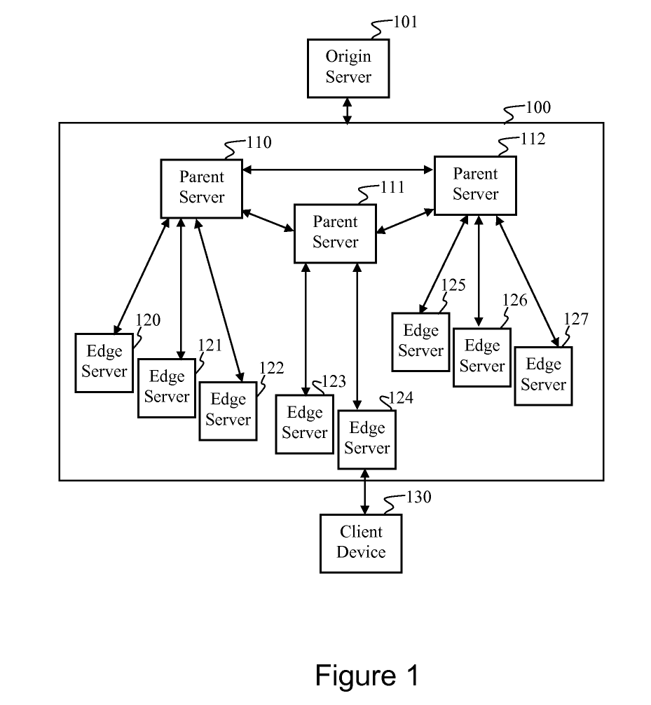

A CDN according to aspects of the invention is illustrated in FIG. 1. The network 100 comprises one or more parent server sites 110-112 and one or more edge server sites 120-127. The network 100 also optionally has access to one or more origin server sites 101. The origin server sites 101 are typically owned and/or maintained by the network provider's customers for storing and serving one or more objects. Content provider companies, organizations, etc. that subscribe to the CDN service are referred to as customers. Each customer (i.e., content provider) may have its own origin server site. One or more clients, such as client 130, access the network 100 to request one or more objects.

As used herein, an object includes, without limitation, an audio file (such as, e.g., an MP3 (Motion Picture Experts Group-1 Layer 3) file and a RealNetworks, Inc. Real format file), a video file (such as an MPEG file), an image file (such as, e.g., a BMP (bitmap) file or JPEG (Joint Photographic Experts) file) and any other software or data file or object.

A parent server site (or simply parent site or parent server) may comprise one parent server or a cluster of parent servers. Likewise, an edge server site (or simply an edge site or edge server) may comprise one edge server or a cluster of edge servers, and an origin server site (or simply an origin site or origin server) may comprise one origin server or a cluster of origin servers. Typically, the network 100 is configured such that servers in a cluster share a common storage. However, aspects of the invention may use a variety of different network configurations.

In a typical CDN, the parent servers 110-112 and edge servers 120-127 are maintained by a network provider, wherein the parent servers 110-112 are primarily used for storing and managing one or more objects, and edge servers 120-127 are primarily used for serving objects to clients 130. End-users or client proxies that access customers' objects are referred to as clients.

In accordance with one aspect of the invention, the parent servers 110-112 and/or the edge servers 120-127 may comprise a mobile wireless network for serving clients 130. As used herein, a mobile wireless network may comprise a cellular network, a wireless local area network, a wireless wide area network, or any other type of wireless network that is capable of serving mobile terminals. The clients 130 may comprise one or more mobile wireless terminals served by at least one mobile wireless network.

In some aspects, all the objects are retrieved from origin servers 101 and stored on one or more parent servers 110-112 before the client 130 can access each such object. Accordingly, in these aspects, the origin servers 101 play no significant role in object replication and delivery except to supply new and/or updated objects for storage on the parent servers 110-112. Moreover, only the parent servers 110-112 communicate with the origin servers 101. In other aspects, each requested object is replicated from one or more origin servers 101 to one or more parent servers 110-112 (and/or one or more edge servers 120-127) when the requested object becomes popular. In these aspects, the origin servers 101 play a more significant role in object replication and delivery to supply objects to parent servers 110-112 and/or edge servers 120-127 when requested. So, in these aspects, the origin servers 101 and the parent servers 110-112 communicate with each other, and the origin servers 110-112 and clients 130 may also communicate with each other. In such aspects, the communications relationships between origin servers 101 and parent servers 110-112 may be one-to-one, one-to-many, or many-to-many.

As shown in FIG. 1, the parent servers 110-112 and edge servers 120-127 communicate with each other, and the edge servers 120-127 and clients 130 communicate with each other. Furthermore, the parent servers 110-112 and clients 130 may communicate with each other. In aspects of the invention illustrated in FIG. 1, the edge servers 120-127 have a one-to-one or one-to-many communications relationship with the parent servers 110-112. In some aspects, the edge servers 120-127 may have many-to-many communications relationships with the parent servers 110-112. Typically, the edge servers 120-127 act as the primary source of serving objects. However, if a requested object is not available at one of the edge servers 120-127, a parent server 110-112 may serve the requested object to the clients 130. FIG. 1 depicts a single layer, or level, of parent servers 110-112 and origin servers 101. As will be apparent to those skilled in the art, more than one layer (or level) of parent servers 110-112 and/or origin servers 101 may be employed.

An edge server 120-127 is selected to serve content to the client 130 based, at least in part, on load conditions on at least some of the edge servers 120-127 and on the client's 130 location. Load balancing takes into account the load at each edge server 120-127 (which can be measured in a variety of ways) to select which edge server 120-127 should handle a particular request. Other techniques may take network performance and topology into account for assigning the edge server 120-127 to serve a client 130.

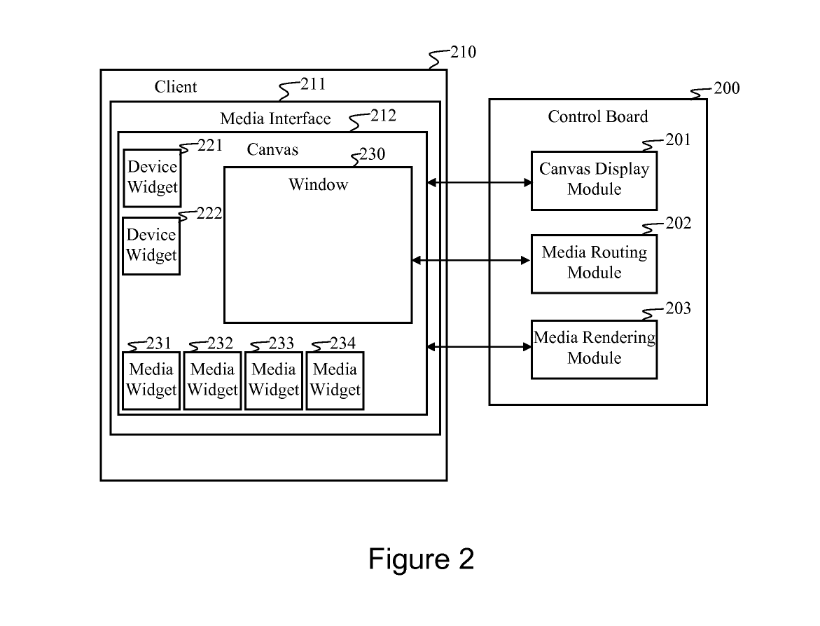

FIG. 2 is a block diagram of a control board 200 configured in accordance with an aspect of the invention. The control board 200 may comprise any combination of hardware and software that enables content providers to manage user interactions with media resources. In one aspect, the control board 200 may comprise a distributed system, meaning that control board components may reside on multiple devices. For example, control board components may reside on multiple servers and/or on multiple client devices.

In one aspect of the invention, the control board 200 comprises software configured to perform control board functions. In another aspect of the invention, the control board 200 comprises hardware configured to perform control board functions. Aspects of the invention may provide for performing control board functions using a combination of hardware and software.

According to one aspect of the invention, the control board 200 comprises a client-device canvas display module 201, a media routing module 202, and a media rendering module 203. The canvas display module 201 is configured for interacting with a canvas 212 displayed on the media interface 211 on a client device 210. The client device 210 is one of a plurality of user-selectable client devices. The canvas 212 is part of a graphical user interface that displays user-controllable devices and available media resources. The canvas 212 may comprise windows, icons, menus, and/or other display items. Mapped onto the canvas 212 are all user-controllable devices, such as laptops, handsets, PDAs, tablets, other mobile client devices, and set-top boxes. The canvas 212 includes canvas display and control software that allows users to experience and control media across multiple client devices, and assign control and viewing interfaces (e.g., windows) to the devices. For example, the display items may include client device widgets 221 and 222, media widgets 231-234, and at least one window 230 for displaying media content.

In one aspect of the invention, the canvas 212 allows for human-computer interaction by enabling the display items to be manipulated by user input, such as by a mouse, keyboard, touch screen, and/or other user controls. The canvas 212 software converts user inputs to messages, which are transmitted to the canvas display module 201 and/or the media routing module 202. The control board 200 may also receive information about the client device 210 and other user-selectable client devices (not shown) automatically, without the need for user input. For example, the media routing module 202 may receive messages from the canvas 212, such as messages indicating which client devices are present, presentation capabilities of each client device, and communication bandwidth available to each client device. The media routing module 202, in response to the canvas 212 messages, may allocate media resources to each client device. The media routing module 202 is responsive to at least one of client device information and user inputs received from the canvas 212 for allocating the media resources to the client device 210 and other user-selectable client devices. The canvas display module 201 may be responsive to user input and/or client device information to configure and/or reconfigure the canvas 212 display. The canvas display module 201 may be responsive to the media routing module for configuring and/or reconfiguring the canvas 212 display.

In one aspect of the invention, the canvas display module 201 is responsive to communication link performance of a client sub-network between multiple client devices for configuring and/or reconfiguring the canvas 212 display. For example, the canvas display module 201 may update which client devices are displayed on the canvas 212 (or which client devices are shown as available) as the link performance of the client sub-network (e.g., a Bluetooth network, an 802.11 network, a wireless USB network, a UWB network, etc.) changes. The media routing module 202 may select which media resources are available to a particular client device based on the sub-network link performance to that client device. Specifically, link performance may comprise an estimate of average data rate, a prediction of future data rate, latency measurements, and/or other measurements or calculations indicating link quality. The link performance may be compared to transmission requirements of the available media resources (e.g., bandwidth, tolerance to latency, activity factor, etc.) and characteristics of the client devices in the sub-network (e.g., buffer size, display capabilities, etc.) in order to determine which media resources are suitable for being delivered to each client device. The media routing module 202 communicates with the canvas display module 201, and the canvas display module 201 may update the canvas 212 to indicate which media resources are available to particular client devices as the sub-network link performance changes.

In some aspects of the invention, software residing on the client 210 may comprise a component of the canvas display module 201. For example, the canvas display module 201 may include graphical user interface software on the client 210. In one aspect, the canvas display module 201 displays which types of media resources are available for a particular client device, as determined by the media routing module 202. The canvas display module 201 instructs the canvas 212 software to configure the display items in accordance with the availability of media resources. Similarly, the canvas display module 201 may instruct the canvas 212 to indicate which client devices may present a particular media resource, and it may instruct the canvas 212 display software to represent the availability of client devices for each selectable media resource.

A window (such as the window 230) may be a rectangular portion of the canvas that displays video contents of a media resource. The window's 230 display may be independent of the rest of the canvas display. Thus, multiple windows, each displaying different content, may reside on the canvas 212. In some aspects of the invention, the window 230 may be displayed inside the device widgets 221 and 222.

The media routing module 202 is responsive to user selections of media resources and is configured for routing selected media resources to at least one user-selected client device, such as the client device 210. For example, the media routing module 202 may be responsive to a user's selection of a streaming video channel and information about the selected client device's 210 capabilities for allocating an available stream bandwidth and delivering the selected video at the allocated stream bandwidth. In one aspect, the selected client device 210 may select a stream bandwidth and inform the media routing module 202 of the selected stream bandwidth via the canvas 212. In response to the selected stream bandwidth, the media routing module 202 may allocate the selected stream bandwidth or a lower stream bandwidth. In one aspect of the invention, the media routing module 202 is communicatively coupled to the window 230, and it may include window-display software residing on the client 210.

The media rendering module 203 configures the media resources according to needs of users and client devices. In one aspect of the invention, the resource rendering module 203 is responsive to a user's selection of a media channel, and it employs the user's selection and the stream bandwidth selected by the media routing module 202 for configuring the media to be presented on at least one user-selected client device. As used herein, rendering refers to presenting, displaying, formatting, representing, depicting, or otherwise conditioning a media resource to be output by a device, such as a client device. The media rendering module 203 may employ client-device information for configuring the media for presentation on the user-selected client device(s), such as client device 210. Thus, the configuring of the media may be device-specific relative to the user-selected client device(s). The media rendering module 203 may configure a client device's presentation capability to render the media. Furthermore, the media rendering module 203 may be responsive to other metrics for rendering the media resources and/or configuring the devices. In some aspects, window size, network congestion, and other factors related to network performance, device performance, and/or user selections and/or preferences may be employed for configuring media resources delivered to the device 210. In one aspect of the invention, the media rendering module 203 selects a particular media channel based on the user's selection and/or capabilities of the user device. The media rendering module 203 may configure the media based on characteristics of the selected media channel, such as whether the media is audio or video, or whether the media is standard definition or high definition video. The media rendering module 203 may configure the media relative to information it receives about the client device and/or information it receives from the media routing module 202. The media rendering module 203 may adapt the rendering of media based on network conditions. For example, in one aspect of the invention, mobile wireless network performance data connecting the device 210 to the CDN may be employed for configuring the media resources delivered to the device 210. In some aspects, the mobile wireless network performance data may further comprise link performance data for any sub-network connecting a plurality of client devices together. The media rendering module 203 may configure image resolution, audio fidelity, buffering, and any other signal processing functions employed for media presentation.

In one aspect of the invention, the media rendering module 203 enables content-provider control of window positioning and content, branding, user input, and user-to-user interactions. Media resources may be configured in the plasma cloud and/or on the client device 210.

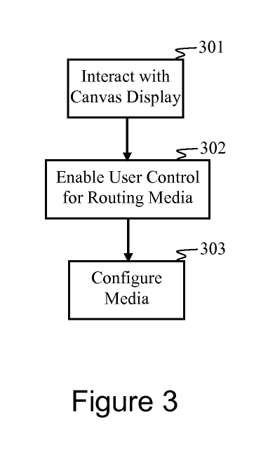

FIG. 3 is a flow diagram of a control-board method for managing user interactions with media resources in accordance with an aspect of the invention. According to one aspect of the invention, the method shown in FIG. 3 may be performed by a control board. A control board may comprise a software application for controlling the presentation of media resources on client devices in real-time, allowing manipulation of both media streams and canvases to create dynamic experiences for the user.

In a first step 301, the control board interacts with canvas display software on a client device. In step 301, the interaction may include initializing the display of available media resources in response to information about which client devices are present. For example, the client device may transmit device information to the control board. The device information may comprise capabilities and configurations about the client device, and it may include information about other client devices to which the client device is connected. The control board may be responsive to the device information for transmitting instructions to the canvas software for displaying available media resources, such as media resources that are available for each device. A control board allows CDN server-side actions, such as broadcaster control of window positioning and content on the client device, branding of client canvases, and defining user affinities and social interactions.

A second step 302 enables user control for selecting media resources and provides for routing the media resources to the client devices. Within the canvas area of a client device, multiple windows may be viewed and can be moved between devices. For example, a user may begin viewing a sporting event on a laptop and move the window seamlessly to a different mobile device, such as a cellular handset.

A third step 303 is performed by the control board in response to user input, such as when a user selects a media resource or routes the media resource from one client device to another. In one aspect of the invention, media streams are configured according to the needs of users and devices. Configuring the media may be device-specific, which means that the media may be configured relative to a selected client device's presentation capabilities and/or the quality of the communication link serving the device. For example, the bandwidth of a video stream can be transformed on the fly when the user moves a window from a semi-mobile device (e.g., a laptop) with broadband internet connectivity to a handset served by a cellular network. In this case, the third step configures the media stream with respect to bandwidth limitations of the cellular network, as the cellular network is typically the bottleneck of an end-to-end link from the content provider (e.g., the edge server) to the selected client device (i.e., the handset).

The performance of the cellular link may be determined from various measurements and calculations that are known in the art, including, but not limited to, bit-error-rate, average data throughput, root mean square data throughput, peak data throughput, latency, and channel estimates. In some cases, the performance of the cellular channel may be determined simply by measuring data throughput parameters (e.g., bit-error-rate, average data throughput, root mean square data throughput, peak data throughput, and/or latency) at the client device or data throughput parameters of a link from the client device to the edge server.

In another aspect of the invention, in the third step 303, video, text, and/or metadata can be modified, inserted, or overlaid in response to user input in step 302.

Although the flow diagram in FIG. 3 describes an aspect of the invention in which the steps 301-303 are a sequential process, in other aspects, two or more of the steps 301-303 may be performed in parallel or concurrently. In addition, the order of the steps 301-303 may be re-arranged. The process shown in FIG. 3 is terminated when its operations are completed. However, the process may comprise additional steps not shown in the figure. The process may correspond to a method, a function, a procedure, a subroutine, a subprogram, etc. When the process corresponds to a function, its termination corresponds to a return of the function to its calling function or main function.

It should be understood that various aspects of the invention may be implemented in hardware, firmware, software, or combinations thereof. In such aspects, any of the steps 301-303 can be implemented in hardware, firmware, and/or software to perform the functions of the present invention. For example, the same piece of hardware, firmware, or module of software may perform one or more of the steps 301-303. Alternatively, one or more of the steps 301-303 may be performed across multiple platforms, such as in a distributed computing environment.

When implemented in software, firmware, middleware or microcode, the program code or code segments that perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

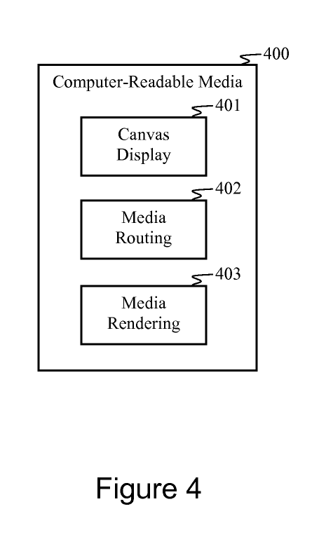

In accordance with one aspect of the invention, a computer program shown in FIG. 4 resides on one or more computer-readable media 400 and is configurable for interacting with a plurality of client-side devices for enabling content providers to manage user interactions with media resources. The computer program comprises a canvas display source-code segment 401, a user-controllable media routing source-code segment 402, and a media rendering source-code segment 403.

As disclosed herein, the term “computer-readable media” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

According to one aspect of the invention, the canvas display source-code segment 401 is configurable for interacting with a canvas on a client device. The source-code segment 401 resides, at least in part, on hardware managed by the content provider. The interaction comprises receiving client information from the client device and controlling (at least in part) what is displayed on the canvas. For example, the source-code segment 401 may control which available media resources are displayed, how the media resources are displayed, and how other client devices are displayed. The source-code segment 401 may initialize the canvas display based on the received client information, which may include at least one of technical specifications of the client device, information about other client devices under the user's control, display settings on the client device(s), user subscription status, user location, user affinities, user preferences, and the like.

The media routing source-code segment 402 resides, at least in part, on the client device and is configurable for enabling user controls for routing media resources to one or more user-controlled client devices. The media routing source-code segment 402 may interact with the canvas display source-code segment 401 such that user selections update the canvas display. For example, in one aspect of the invention, when a user selects a particular client device on the canvas, the media routing source-code segment 402 sends a message to the canvas display source-code segment 401 indicating the device selection. The canvas display source-code segment 401 responds by updating which media resources may be presented on the selected device.

The media rendering source-code segment 403 is configured for adapting the media resources according to the needs of the user and/or the client devices. In one aspect of the invention, the source-code segment 403 is responsive to display capabilities of a selected client device, and it presents appropriately formatted media for that device. In another aspect of the invention, the source-code segment 403 is responsive to link performance between the CDN (e.g., an edge server) and the client device for adapting the media resources to the bandwidth of the communication link. In some aspects of the invention, the source-code segment 403 may combine, format, overlay, or otherwise process media on the client device and/or on the CDN prior to delivery to the client device.

In one aspect of the invention, at least one of the client devices comprises a mobile terminal communicatively coupled to a mobile wireless network. The step of configuring the media resources employs analyzing performance of the communication link between a CDN to a client device for selecting which media resources to make available to the client device. The performance of the communication link typically depends highly on the performance of the mobile wireless network, and the quality of wireless link can fluctuate greatly due to many factors, including fading, shadowing, network loading, interference, and service interruptions while transferring to adjacent sectors and cells.

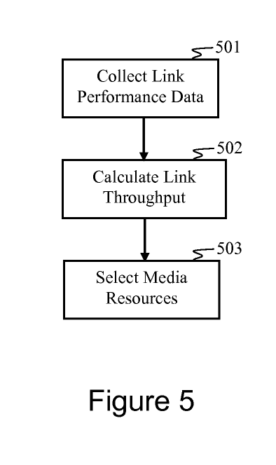

FIG. 5 illustrates a method that may be performed by the media resource rendering module 203 shown in FIG. 2, Step 303 of the method illustrated in FIG. 3, or the media rendering source-code segment 403 in FIG. 4.

In one aspect of the invention, a link performance collection step 501 comprises collecting network performance data directly from a cellular network. Network performance data may comprise network loads, average bit error rate, power levels, coverage area, quality of service, and link budgets for the mobile wireless network in the vicinity of the client device. Network performance data may include many different types of calculations and measurements pertaining to how well the mobile wireless network is able to serve the client device. For example, network performance data may comprise measurements and/or calculations of link reliability, average link throughput, peak link throughput, and/or latency.

In another aspect of the invention, the link performance collection step 501 comprises collecting network performance data that is specific to the client device. Such data may be collected from the client device and/or the mobile wireless network. For example, network performance data may include the client's assigned transmit power level, measured bit error rate, channel estimates of the wireless link connecting the client to the network, average data rate, latency, and/or the coding rate of any channel coding or error correction coding employed. Other network performance data may be obtained from measurements produced by the client and/or the network.

A performance analysis step, such as link-throughput calculation 502, may comprise indirectly analyzing the performance of the mobile wireless network. For example, since the wireless link is typically the bottleneck of a data network, aspects of the invention may provide for measuring the overall performance of a heterogeneous network (i.e., a network comprising wireless and wired network portions).

A media resource selection step 503 comprises selecting which media resources to make available to the client device. For example, step 503 typically comprises selecting media resource bandwidths that are appropriate for the communication link serving the client. For example, screen size in pixels and the number of frames per second of a video transmission may be selected not to exceed a predetermined threshold calculated from the client's measured or estimated communication link bandwidth. Specifically, the bandwidth of the media resource should not exceed the average bandwidth of the link unless some degree of latency is tolerable. Thus, various considerations in addition to the wireless link performance may be employed as part of the step of selecting the media resources 503.

According to one aspect of the invention, a control board comprises a plasma API (application programming interface) application program. As used herein, a plasma is a set of plasma objects (including software programs, databases, libraries, media resources, and the like) communicatively coupled together (such as via a computer network) such that individual objects are capable of interacting with each other. An API is an interface that defines the ways in which an application program may request resources and/or services from the plasma. The API specifies the vocabulary and calling conventions that an application program should employ to access plasma objects. The API typically comprises specifications for routines, data structures, object classes, and protocols used by an application program to interact with the plasma objects. For example, the plasma API allows separate plasma objects to communicate and interact with each other.

In one aspect of the invention, the plasma comprises plasma objects deployed across functional domains. These functional domains include a content-aggregation domain, a content-management, and a content-acquisition domain. In accordance with some aspects of the invention, a control board can be defined by how it functions within one or more of the functional domains.

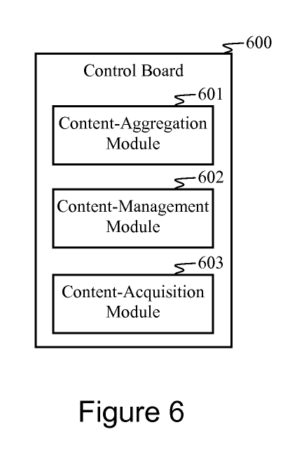

FIG. 6 is a block diagram of a control-board application 600 for enabling a content provider to manage user access to media resources. Such management enables all media elements and canvases to be controlled and reconfigured by the content provider. The control-board application comprises a content-aggregation means 601, a content-management means 602, and a content-acquisition means 603.

The content-aggregation means 601 is configured for aggregating a plurality of media resources. For example, the media resources may include satellite feeds, broadcast streams, video on demand, stored video, live video, audio files, user-generated content, advertisements, and data. Media resources may include software applications, such as client-side applications that may be used in social networking applications. Other types of media resources may also be processed.

The content-management means 602 is configured for managing client access to media resources. For example, the content-management means 602 may perform user authentication and authorization functions.

The content-acquisition means 603 is configured for distributing media to a plurality of disparate client devices. The content-acquisition means 603 provides client control of media streams for enabling the client to route the streams to multiple client devices. Also, the control board allows the content provider to manage the presentation of media on client devices, such as providing broadcaster control of window positioning and content, branding client canvases, and defining user affinities and social interactions. For example, the content-acquisition means 603 can allow users to choose from multiple camera views of a sporting event and even participate in real-time interviews.

In one aspect of the invention, at least one of the content-management means 602 and the content-acquisition means 603 is configurable for adapting the flow of media resources to clients based on performance of at least one segment of the network, such as a wireless network serving the clients.

In accordance with one aspect of the invention, a control board comprises multiple plasma objects for creating flexible integration layers for diverse hardware and software platforms. These plasma objects enable flexible connections across and within functional domains that are transparent to location or platform.

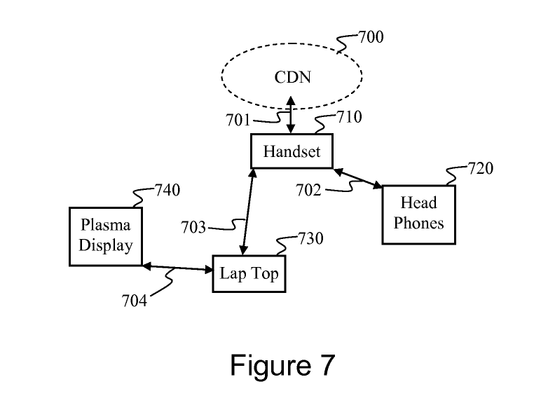

FIG. 7 is a block diagram of a network configuration pertaining to the function of the content-acquisition means 603 according to one aspect of the invention. A client device, such as handset 710, is communicatively coupled to a CDN 700 via a cellular link 701 of a cellular network. Furthermore, the handset 710 is communicatively coupled to head phones 720 via a Bluetooth link 702. The handset 710 is communicatively coupled to a lap top computer 730 via an 802.11 link 703, and the lap top 730 is communicatively coupled to a plasma display 740 via an UWB link 704.

In one aspect of the invention, the client-device canvas display module 201 shown in FIG. 2 displays the client devices 710, 720, 730, and 740 on the canvas 212. The canvas display module 201 may comprise link-monitoring and/or device-detection capabilities. This display may be updated as the link quality of any portions of the client sub-network 702, 703, and 704 changes. For example, the Bluetooth link 720 has a short range, so if the handset 710 and the headphones 720 are separated by more than a few meters, the handset 710 will no-longer detect the headphones 720. A device-detection component (not shown) of the canvas display module 201 updates the display to show that the headphones are no longer available.

The UWB link 704 connecting the lap top 730 to the plasma display 740 is also a short-range link, which is susceptible to interruption if the link 704 is obstructed or the devices 730 and 740 are separated. The canvas display module 201 may comprise a link-monitoring and/or device-detection component that resides on the lap top 730 and is configurable for directing the canvas display module 201 to update the display to show when the plasma display 740 is no longer available.

In one aspect of the invention, a second client device of the client sub-network 702, 703, 704 comprises a second connection to the CDN 700. For example, the lap top 730 may comprise a broadband cable link (not shown) to the CDN 700. In this case, the media resource routing module 202 is configurable to detect the broadband cable link and route selected media resources via the broadband cable link. According to one aspect of the invention, the media resource routing module 202 determines the optimal path for routing selected media resources depending on any combination of factors, including link bandwidth, device power consumption, and the cost of available communication services to the user.

The media resource rendering module 203 obtains information about the client sub-network and may configure the media resources accordingly. In one aspect, the client device 710 passes information about its sub-network (such as sub-network link bandwidths) to the rendering module 203. In another aspect, the rendering module 203 comprises components residing on multiple devices of the sub-network that monitor sub-network link performance and/or detect and monitor all the communication links to the CDN 700.

The canvas display source-code segment 401 shown in FIG. 4 may be configured to perform the same functions as those described with respect to the canvas display module 201. Similarly, the media routing source-code segment 402 may perform similar functions as those performed by the media resource routing module 202, and the media rendering source-code segment 403 may perform similar functions as those performed by the media resource rendering module 203.

In one aspect of the invention, the third step 303 shown in FIG. 3 further comprises adapting the media streams with respect to limitations on the performance of the client sub-network. Accordingly, the step 303 may comprise collecting performance information about the client sub-network.

With respect to FIG. 5, the link performance collection step 501 may further comprise collecting network performance data for the client sub-network.

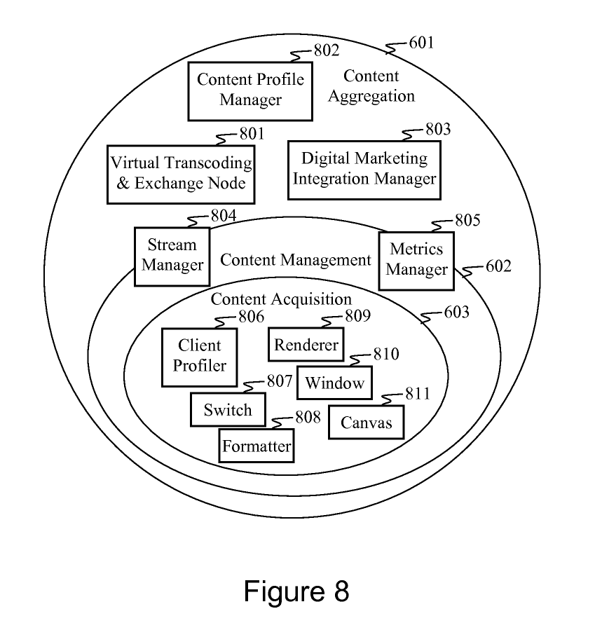

FIG. 8 is a block diagram of plasma objects 801-811 that may be employed by a control board in accordance with some aspects of the invention. The plasma objects 801-811 are depicted as functional elements distributed with respect to functional domains 821-823. Specifically, these objects 801-811 are depicted within the functional domain(s) 821-823 that best corresponds to their respective functions. However, it should be appreciated that any of these objects 801-811 may operate within the other functional domains 821-823. Furthermore, any of these objects 801-811 may be combined or modified to operate in different combinations of the functional domains 821-823, and such variations are anticipated by the applicants and covered within the scope of the claimed invention.

The content-aggregation means 601 comprises a Virtual Transcoding and Exchange node 801, a content profile manager 802, and a digital marketing integration manager 803. The Virtual Transcoding and Exchange node 801 is configurable for at least one of repurposing, transforming, and distributing media streams, user metrics, and data. The content profile manager 802 is configurable for categorizing and grouping media streams. The digital marketing integration manager 803 inserts advertisements into the media streams.

The content-management means 602 comprises a stream manager 804 for authenticating clients and authorizing client access to the media streams. A metrics manager 805 performs inspection of client metrics and meta information, and may perform a combination of real-time and forensic analysis. The function of the metrics manager can reside in both content aggregation 821 and content management 822 domains.

The content-acquisition means 603 comprises at least one of a client profiler 806, a switch 807, a formatter 808, a renderer 809, a window 810, and a canvas 811. The client profiler 806 ensures the integrity of client software and devices through verification of sessions, checksums, and user authentication. The switch 807 manages connections and routing of media resources to the client devices. The formatter 808 formats the received media for presentation by the client devices. The renderer 809 renders media using client-side tools and APIs. The window 810 provides both client control and content-provider control of the display properties of a received media resource. The canvas 811 maps the windows and can manage window instances across multiple client devices.

Although the plasma objects 801-811 depicted in FIG. 8 are described as functional elements, in one aspect of the invention, the plasma objects 801-811 are software components. In another aspect of the invention, the plasma objects 801-811 include the hardware components of the content delivery network configured to perform the recited functions. Aspects of the invention may include various combinations of hardware and software. In one aspect of the invention, a method may be provided by the functions described with respect to the plasma objects 801-811.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant arts.

1. A system comprising:
a client-device canvas residing on a client device and comprising a user control for selecting at least one of a plurality of user-selectable client devices; and
a control board residing on a CDN configured for interacting with the client-device canvas, the control board comprising:
a media routing module responsive to the client-device canvas for indicating at least one media resource for each of the plurality of user-selectable client devices; and
a media rendering module responsive to a user selection of at least one of the plurality of user-selectable client devices for providing device-specific configuring of the at least one media resource.

2. The system recited in claim 1, wherein the client-device canvas comprises a user control for selecting at least one of a plurality of media resources.

3. The system recited in claim 1, wherein the client-device canvas comprises a graphical user interface for displaying the plurality of user-selectable client devices and a plurality of media resources.

4. The system recited in claim 1, wherein the client-device canvas resides on each of the plurality of user-selectable client devices.

5. The system recited in claim 1, wherein the rendering module is configurable for adapting the at least one media resource in response to a measured performance of a wireless link employed by at least one client device.

6. The system recited in claim 1, wherein the control board further comprises a canvas display module responsive to at least one of the media routing module, the media rendering module, and the canvas for configuring a display on the canvas.

7. The system recited in claim 1, wherein the media rendering module resides on at least one of the plurality of user-selectable client devices and the CDN.

8. The system recited in claim 1, wherein at least one of the media routing module and the media rendering module is responsive to network performance data.

9. The system recited in claim 1, wherein the media rendering module comprises components residing on one or more client devices of a sub-network for monitoring sub-network link performance.

10. A method comprising:
providing a user control on a client-device canvas for selecting at least one of a plurality of user-selectable client devices; and
providing a control board residing on a CDN configured for interacting with the client-device canvas, the control board configured for:
allocating at least one media resource for each of the plurality of user-selectable client devices; and
performing device-specific configuring of the at least one media resource in response to a user selection of at least one of the plurality of user-selectable client devices.

11. The method recited in claim 10, further comprising providing a user control for selecting at least one of a plurality of media resources.

12. The method recited in claim 10, wherein the client-device canvas comprises a graphical user interface for displaying the plurality of user-selectable client devices and a plurality of media resources.

13. The method recited in claim 10, wherein the client-device canvas resides on each of the plurality of user-selectable client devices.

14. The method recited in claim 10, wherein performing device-specific configuring comprises adapting the at least one media resource in response to a measured performance of a wireless link employed by at least one client device.

15. The method recited in claim 10, wherein the control board is configured for presenting a display on the canvas.

16. The method recited in claim 10, wherein performing device-specific configuring processes media resources on at least one of the plurality of user-selectable client devices and the CDN.

17. The method recited in claim 10, wherein at least one allocating and performing device-specific configuring is responsive to network performance data.

18. The method recited in claim 10, wherein performing device-specific configuring comprises collecting performance information about a client sub-network.

19. A machine-readable medium comprising instructions encoded thereon and executable to:
provide a user control on a client-device canvas to enable selecting at least one of a plurality of user-selectable client devices; and
provide a control board residing on a CDN configured for interacting with the client-device canvas, the control board configured for:
allocating at least one media resource for each of the plurality of user-selectable client devices; and
performing device-specific configuring of the at least one media resource in response to a user selection of at least one of the plurality of user-selectable client devices.

20. A control board for enabling a content provider to manage user access to media resources, the control board comprising:
a content-aggregation module for aggregating a plurality of media resources;
a content-management module for managing client access to the plurality of media resources; and
a content-acquisition module for distributing media to a plurality of disparate client devices, enabling client control and content-provider control of the media, and conditioning the media in response to user-controlled routing.

21. The control board recited in claim 20, wherein the content-acquisition module is configurable for adapting the media with respect to network performance of a wireless link serving at least one client device.

22. The control board recited in claim 20, wherein the media resources include at least one of a set, the set comprising a satellite feed, a broadcast stream, video on demand, stored video, live video, user-generated content, advertisements, and data.

23. The control board recited in claim 20, wherein the content-aggregation module comprises a Virtual Transcoding and Exchange node configurable for at least one of repurposing, transforming, and distributing media, user metrics and data.

24. The control board recited in claim 20, wherein the content-aggregation module comprises a content profile manager for categorizing and grouping media streams.

25. The control board recited in claim 20, wherein the content-aggregation module comprises a digital marketing integration manager for inserting advertisements into media streams.

26. The control board recited in claim 20, wherein the content-management module comprises a stream manager for authenticating clients and authorizing client access to media streams.

27. The control board recited in claim 20, wherein the content-acquisition module comprises at least one of a client profiler, a switch, a formatter, a renderer, a window, and a canvas.
